(19) United States
(12) Patent Application Publication
(10) Pub. No.: US 2016/0169432 A1
(43) Pub. Date: Jun. 16, 2016

(54) HYDRAULIC CYLINDER JOINT AND HYDRAULIC CYLINDER PIPE INCLUDING SAME

(71) Applicant: LES INDUSTRIES TOURNEBO INC., Sainte-Julienne (CA)

(72) Inventor: Simon PROULX-CROTEAU, St-Charles-Borromee (CA)

(21) Appl. No.: 14/572,111

(22) Filed: Dec. 16, 2014

(51) Int. Cl. F16L 37/244; F16L 21/08; F16L 21/035

(52) U.S. Cl. CPC F16L 37/244; F16L 21/035; F16L 21/08

(57) ABSTRACT

A hydraulic cylinder pipe is provided that includes longitudinally aligned first and second pipe sections, and a hydraulic cylinder joint coupling the first pipe section and the second pipe section. The joint includes a female and a male collar; a plurality of circumferentially distributed L-shaped grooves formed in one of the collars, each having an introduction section and a locking section with an abutting edge; a corresponding plurality of circumferentially distributed protruding disks provided in the other one of the collars; and a circumferential collar stopping shoulder associated with one of the collars. The male collar is inserted in the female collar with the collar not associated with the stopping shoulder abutting against the stopping shoulder and each disk engaged in the locking section of a corresponding groove and abutting against the abutting edge thereof. A hydraulic cylinder joint for a hydraulic cylinder including two pipe sections is also provided.

### TECHNICAL FIELD

The technical field generally relates to pipe couplings and, more specifically, to joints for coupling pipe sections together, such as used in hydraulic cylinders.

### BACKGROUND

Long hydraulic cylinders are manufactured in several parts that must be assembled. Long hydraulic cylinders can be used for hydraulic elevators for instance.

Some components of long hydraulic cylinders, especially the hydraulic cylinder pipe sections, are generally heavy and bulky. Assembling these components may be time consuming. Threaded couplings, such as described in U.S. Pat. No. 4,219,226, are typically used. To screw the two hydraulic cylinder pipe sections together, they must be perfectly aligned with each other. Otherwise, the joint thread may be damaged, causing delays and additional costs for substituting the damaged joint.

Furthermore, in most implementations, the hydraulic cylinder joint must be substantially mechanically strong and fluid tight.

In view of the above, there is a need for a hydraulic cylinder joint which would be able to overcome or at least minimize some of the above-discussed prior art concerns.

### SUMMARY

According to a general aspect, there is provided a hydraulic cylinder pipe comprising:
a first pipe section;
a second pipe section aligned with the first pipe section along a longitudinal axis; and
a hydraulic cylinder joint coupling the first pipe section and the second pipe section, the hydraulic cylinder joint comprising:
   a female collar having a proximal axial end and an inner surface defining an inner channel extending axially therein, the female collar extending from the first pipe section along the longitudinal axis;
   a male collar having a proximal axial end, an outer surface, and an opposed inner surface defining an inner channel extending axially therein, the male collar extending from to the second pipe section along the longitudinal axis;
   a plurality of circumferentially distributed L-shaped grooves formed in one of the inner surface of the female collar and the outer surface of the male collar, each L-shaped groove having an introduction section and a locking section with an abutting edge, the introduction section being closer to the proximal axial end of the one of the female collar and the male collar than the locking section;
   a corresponding plurality of circumferentially distributed protruding disks provided in the other one of the inner surface of the female collar and the outer surface of the male collar, the protruding disks protruding from the other one of the inner surface of the female collar and the outer surface of the male collar; and
   a circumferential collar stopping shoulder associated with one of the female and male collars, wherein the circumferential collar stopping shoulder is respectively one of a circumferential female-collar stopping shoulder protruding outwardly from the outer surface of the male collar and axially spaced-apart from the proximal axial end thereof and a circumferential male collar stopping shoulder protruding inwardly from the inner surface of the female collar and axially spaced-apart from the proximal axial end thereof;
the male collar being inserted in the inner channel of the female collar with the one of the female and male collars not associated with the circumferential collar stopping shoulder abutting against the circumferential collar stopping shoulder and with each of the protruding disks being engaged in the locking section of a corresponding one of the L-shaped grooves and abutting against the abutting edge thereof.

In some implementations, the circumferential collar stopping shoulder is associated with the male collar, and the abutting edge of each of the L-shaped grooves is a proximal abutting edge.

In some implementations, the hydraulic cylinder joint further comprises at least one circumferential resilient sealing member, each circumferential resilient sealing member circumscribing one of the inner surface of the female collar and the outer surface of the male collar, the at least one circumferential resilient sealing member being closer to the introduction sections of the L-shaped grooves than to the locking sections.

In some implementations, the male collar comprises at least one circumferential groove defined in the outer surface thereof, adjacent to the proximal axial end thereof, each of the at least one circumferential resilient sealing member being inserted in a corresponding one of the at least one circumferential groove.

In some implementations, the at least one circumferential groove consists of two circumferential grooves with a circumferential separation flange extending therebetween, and the at least one circumferential resilient sealing member consists of two circumferential resilient sealing members.

In some implementations, each one of the male collar and the female collar comprises a connecting region and a sealing region, with the connecting region of the female collar being closer to the proximal axial end than the sealing region and the sealing region of the male collar being closer to the proximal axial end than the sealing region, an external diameter of the male collar being larger in the connecting region than in the sealing region and the inner channel of the female collar being wider in the connecting region than in the sealing region.

In some implementations, each of the L-shaped grooves has an opposing edge, axially spaced-apart from the abutting edge, the abutting edge and the opposing edge defining therebetween a disk guiding path extending continuously between the introduction section and the locking section.

In some implementations, a width of the disk guiding path is substantially uniform from the introduction section to the locking section.

In some implementations, the opposing edge of each of the L-shaped grooves is axially spaced-apart from the corresponding one of the protruding disks.

In some implementations, the abutting edge of the locking section of each of the L-shaped grooves defines an angle ranging between 81.5° and 89° with the longitudinal axis.

In some implementations, a circumferential extent of the L-shaped grooves is equal to or shorter than a longitudinal extent of the L-shaped grooves.

In some implementations, the L-shaped grooves are defined in the outer surface of the male collar and the protruding disks protrude from the inner surface of the female collar.

In some implementations, each L-shaped groove has a transition section extending between the introduction and the locking sections thereof.

In some implementations, the transition section includes a straight mid-segment making an angle of about 20° to about 30° with the longitudinal axis.

In some implementations, the protruding disks are squeeze-fit in respective through holes formed in the other one of the inner surface of the female collar and the outer surface of the male collar.

In some implementations, the female and male collars are welded to the first and second pipe sections, respectively.

In some implementations, the female collar is secured to the first pipe section by insertion of an end portion of the first pipe section into the female collar through a distal axial end thereof, and the male collar is secured to the second pipe section by insertion of an end portion of the second pipe section into the male collar through a distal axial end thereof.

In some implementations, the plurality of L-shaped grooves consists of six L-shaped grooves, and the corresponding plurality of protruding disks consists of six protruding disks.

In some implementations, the L-shaped grooves and the protruding disks are evenly distributed around the respective one of the male collar and the female collar.

In some implementations, each of the protruding disks includes a flat surface along a portion of a periphery thereof, the flat surface abutting against the abutting edge of the corresponding one of the L-shaped grooves.

In some implementations, each of the protruding disks is engaged in the locking section of the corresponding one of the L-shaped grooves in a spaced-apart relationship with an end of L-shaped groove in the locking section.

In some implementations, the hydraulic cylinder pipe further comprises a pressure screw extending along and threadedly engaged into a threaded aperture formed in the female collar, the pressure screw pressing radially inwardly against the outer surface of the male collar.

According to another general aspect, there is provided a hydraulic cylinder joint for a hydraulic cylinder including a first pipe section and a second pipe section, the hydraulic cylinder joint comprising:
a female collar having a proximal axial end and an inner surface defining an inner channel extending axially therein along a longitudinal axis thereof, the female collar being securable to the first pipe section;
a male collar having a proximal axial end, an outer surface, and an opposed inner surface defining an inner channel extending axially therein along a longitudinal axis thereof, the male collar being securable to the second pipe section;
a plurality of circumferentially distributed L-shaped grooves formed in one of the inner surface of the female collar and the outer surface of the male collar, each L-shaped groove having an introduction section and a locking section with an abutting edge, the introduction section being closed to proximal axial end of the one of the female collar and the male collar than the locking section;
a corresponding plurality of circumferentially distributed protruding disks provided in the other one of the inner surface of the female collar and the outer surface of the male collar, the protruding disks protruding from the other one of the inner surface of the female collar and the outer surface of the male collar; and a circumferential collar stopping shoulder associated with one of the female and male collars, wherein the circumferential collar stopping shoulder is respectively one of a circumferential female-collar stopping shoulder protruding outwardly from the outer surface of the male collar and axially spaced-apart from the proximal axial end thereof and a circumferential male collar stopping shoulder protruding inwardly from the inner surface of the female collar and axially spaced-apart from the proximal axial end thereof;
the male collar being insertable in the inner channel of the female collar through the proximal axial end of the female collar and being configurable in a coupled configuration with the female collar, wherein the one of the female and male collars not associated with the circumferential collar stopping shoulder abuts against the circumferential collar stopping shoulder and wherein each of the protruding disks is engaged in the locking section of a corresponding one of the L-shaped grooves and abuts against the abutting edge thereof.

In some implementations, the circumferential collar stopping shoulder is associated with the male collar, and the abutting edge of each of the L-shaped grooves is a proximal abutting edge.

In some implementations, the hydraulic cylinder further comprises at least one circumferential resilient sealing member, each circumferential resilient sealing member circumscribing one of the inner surface of the female collar and the outer surface of the male collar, wherein, in the coupled configuration, the at least one circumferential resilient sealing member are closer to the introduction sections of the L-shaped grooves than to the locking sections.

In some implementations, the male collar comprises at least one circumferential groove defined in the outer surface thereof, adjacent to the proximal axial end thereof, each of the at least one circumferential resilient sealing member being inserted in a corresponding one of the at least one circumferential groove.

In some implementations, the at least one circumferential groove consists of two circumferential grooves with a circumferential separation flange extending therebetween, and the at least one circumferential resilient sealing member consists of two circumferential resilient sealing members.

In some implementations, each one of the male collar and the female collar comprises a connecting region and a sealing region, with the connecting region of the female collar being closer to the proximal axial end than the sealing region and the sealing region of the male collar being closer to the proximal axial end than the sealing region, an external diameter of the male collar being larger in the connecting region than in the sealing region and the inner channel of the female collar being wider in the connecting region than in the sealing region.

In some implementations, each of the L-shaped grooves has a free edge, axially spaced-apart from the abutting edge, the abutting edge and the free edge defining therebetween a disk guiding path extending continuously between the introduction section and the locking section.

In some implementations, a width of the disk guiding path is substantially uniform from the introduction section to the locking section.

In some implementations, in the coupled configuration, the free edge of each of the L-shaped grooves is axially spaced-apart from the corresponding one of the protruding disks.

In some implementations, the abutting edge of the locking section of each of the L-shaped grooves defines an angle ranging between 81.5° and 89° with the longitudinal axis of the one of the female collar and the male collar.

In some implementations, a circumferential extent of the L-shaped grooves is equal to or shorter than a corresponding longitudinal extent of the L-shaped grooves.

In some implementations, the L-shaped grooves are defined in the outer surface of the male collar and the protruding disks protrude from the inner surface of the female collar.

In some implementations, each L-shaped groove has a transition section extending between the introduction and the locking sections thereof.

In some implementations, the transition section includes a straight mid-segment making an angle of about 20° to about 30° with respect with the longitudinal axis of the one of the female collar and the male collar.

In some implementations, the protruding disks are squeeze-fit in respective through holes formed in the other one of the inner surface of the female collar and the outer surface of the male collar.

In some implementations, the female collar is securable to the first pipe section by insertion of an end portion of the first pipe section into the female collar through a distal axial end thereof, and the male collar is securable to the second pipe section by insertion of an end portion of the second pipe section into the male collar through a distal axial end thereof.

In some implementations, the plurality of L-shaped grooves consists of six L-shaped grooves, and the corresponding plurality of protruding disks consists of six protruding disks.

In some implementations, the L-shaped grooves and the protruding disks are evenly distributed around the respective one of the male collar and the female collar.

In some implementations, each of the protruding disks includes a flat surface along a portion of a periphery thereof, and, in the coupled configuration, the flat surface abuts against the abutting edge of the corresponding one of the L-shaped grooves.

In some implementations, in the coupled configuration, each protruding disk is engaged in the locking section of the corresponding one of the L-shaped grooves in a spaced-apart relationship with an end L-shaped groove in the locking section.

In some implementations, the hydraulic cylinder joint further comprises a pressure screw threadedly engageable into a threaded aperture formed in the female collar, the pressure screw pressing radially inwardly against the outer surface of the male collar in the coupled configuration.

According to still another general aspect, there is provided a process to manufacture a hydraulic cylinder joint as described herein, the process comprising at least one of machining and molding the female collar and the male collar.

According to a further general aspect, there is provided a process to manufacture a hydraulic cylinder pipe, the process comprising:
providing a first pipe section and a second pipe section;
providing a hydraulic cylinder joint as described herein;
securing the female collar to the first pipe section and the male collar to the second pipe section;
inserting the male collar into the female collar; and
providing a relative rotation between the male collar and the female collar to configure the hydraulic cylinder joint in the coupled configuration.

In some implementations, the step of providing the hydraulic cylinder joint comprises at least one of machining and molding the female collar and the male collar.

In some implementations, the manufacturing process further comprises a step of machining the L-shaped grooves in one of the inner surface of the female collar and the outer surface of the male collar, and inserting the protruding disks in apertures defined in the other one of the inner surface of the female collar and the outer surface of the male collar.

According to still a further general aspect, there is provided a use of the hydraulic cylinder pipe as described herein for a mechanical translation system.

According to yet another general aspect, there is provided an elevator comprising at least one of the hydraulic cylinder pipe as described herein.

According to yet a further general aspect, there is provided a crane comprising at least one of the hydraulic cylinder pipe as described herein.

### BRIEF DESCRIPTION OF THE DRAWINGS

FIG. 1 is a perspective view of a hydraulic cylinder pipe including a hydraulic cylinder joint in accordance with an embodiment, depicted in a coupled configuration;

FIG. 2 is a perspective view of the hydraulic cylinder pipe shown in FIG. 1, where in the hydraulic cylinder joint is in a disengaged configuration;

FIG. 3 is a perspective view of the hydraulic cylinder joint shown in FIG. 1, in the coupled configuration;

FIG. 4 is a side elevation view of a male collar of the hydraulic cylinder joint shown in FIG. 1;

FIG. 5 is a side elevation view of the male collar shown in FIG. 4, showing an angle of a locking section of a L-shaped groove;

FIG. 6 is a side elevation view of the male collar shown in FIG. 4, showing an angle of an introduction section and an angle of a transition section of the L-shaped groove;

FIG. 7 is a cross-sectional view of a female collar of the hydraulic cylinder joint shown in FIG. 1;

FIG. 8 is a cross-sectional view of the female collar shown in FIG. 7, showing an angle of a flat section of a protruding disk;

FIG. 9 is side elevation view of the protruding disk of the female collar shown in FIG. 7;

FIG. 10 is a side elevation view of the male collar shown in FIG. 4 and the female collar shown in FIG. 7 being engaged to one another to configure the hydraulic cylinder joint in the coupled configuration; and

FIG. 11 is a partially transparent side elevation view of the hydraulic cylinder joint in the coupled configuration.

### DETAILED DESCRIPTION

Although the embodiments of the hydraulic cylinder joint and corresponding parts thereof consist of certain geometrical configurations as explained and illustrated herein, not all of these parts and geometries are essential and thus should not be taken in their restrictive sense. It is to be understood, as also apparent to a person skilled in the art, that other suitable components and cooperation therebetween, as well as other suitable geometrical configurations, may be used for the hydraulic cylinder joint, as will be briefly explained herein and as can be easily inferred herefrom by a person skilled in the art. Moreover, it will be appreciated that positional descriptors such as “above”, “below”, “left”, “right” and other like term indicating the position of one element with respect to another element are used herein for ease and clarity of description and should, unless otherwise indicated, be taken in the context of the figures and should not be considered limiting. It will be understood that such spatially relative terms are intended to encompass different orientations of the hydraulic cylinder joint in use or operation, in addition to the orientations exemplified in the figures.

In the following description, the same numerical references refer to similar elements. Furthermore, for the sake of simplicity and clarity, namely so as to not unduly burden the figures with several references numbers, not all figures contain references to all the components and features. In particular, references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

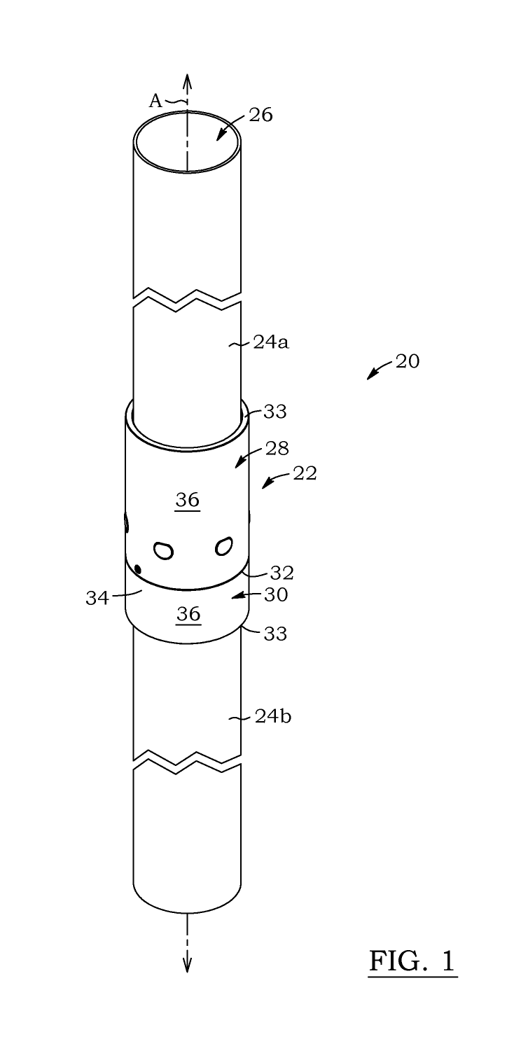

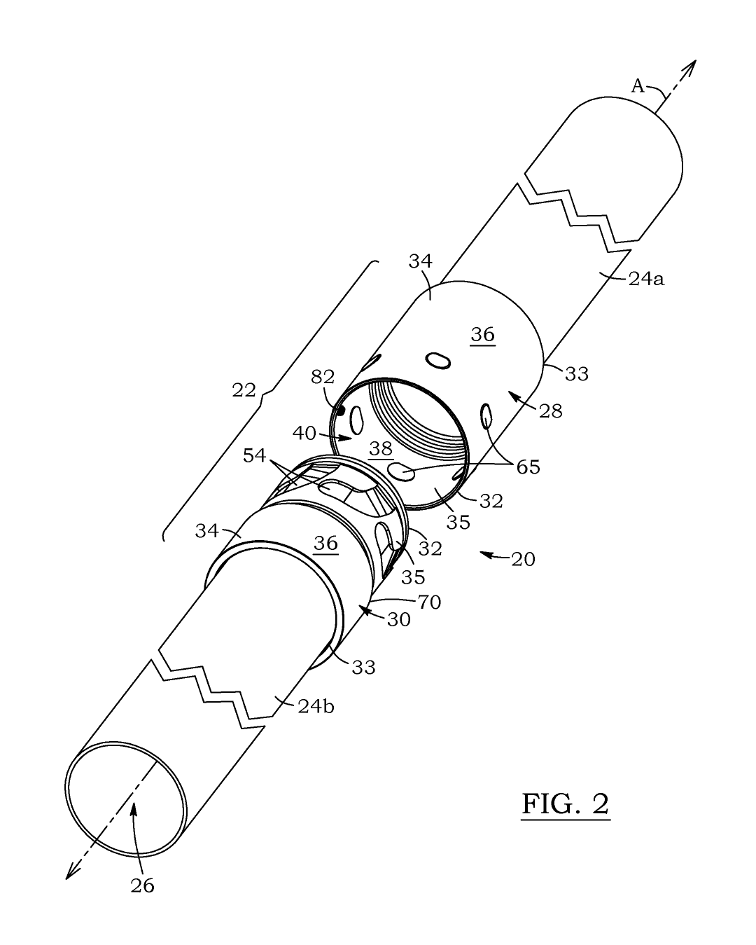

Referring now to the Figures and, more particularly, to FIG. 1, there is shown a section of a hydraulic cylinder pipe 20 including a hydraulic cylinder joint 22 in accordance with an embodiment. The hydraulic cylinder pipe 20 includes a first pipe section 24a and a second pipe section 24b that are coupled together through the hydraulic cylinder joint 22. The first pipe section 24a and the second pipe section 24b are aligned with one another and extend along a longitudinal axis A. In FIG. 1, the hydraulic cylinder joint 22 is configured in a coupled configuration wherein the pipe sections 24a, 24b are in an assembled relation, thereby defining a continuously extending inner channel 26 therein, as will be described in more detail below. In FIG. 2, the hydraulic cylinder joint 22 is configured in a disengaged configuration wherein the pipe sections 24a, 24b are disassembled from one another.

For instance, in some implementations, the hydraulic cylinder pipe 20 can be used as a hydraulic cylinder of a hydraulic elevator wherein the pipe sections 24a, 24b are connected together to extend the length of the hydraulic cylinder.

In the embodiment shown in FIGS. 1 and 2, only one hydraulic cylinder joint 22 is shown, coupling two pipe sections 24a, 24b. It is appreciated that the hydraulic cylinder pipe 20 can include more than two pipe sections, each one of the pipe sections being connected to an adjacent one of the pipe sections through one of the hydraulic cylinder joints 22.

In the embodiment shown in FIG. 1, the first pipe section 24a is shown as being the upper section, and the second pipe section 24b is shown as being the lower section, of a vertically oriented hydraulic cylinder pipe 20. However, their positions can be reversed. Furthermore, the orientation of the hydraulic cylinder pipe 20 can differ from the embodiment shown. For instance, and without being limitative, the hydraulic cylinder pipe 20 can be horizontally oriented.

In the embodiment shown in FIGS. 1 and 2, the first and second pipe sections 24a, 24b are of similar dimensions with an inner channel 26 extending along the longitudinal axis A. For example, in a non-limitative embodiment, the external diameter of each of the female and male collars 28, 30 can range from about 4 inches to about 12.75 inches. Of course, these values are provided for illustrative purposes only and can differ in other embodiments. It may also be envisioned that, in other embodiments, the dimensions of the first and second pipe sections 24a, 24b be different from each other, for example in terms of their internal diameters. Furthermore, in a non-limitative embodiment, each of the male and female collars 28, 30 is an AISI 1020/1026 drawn-over-mandrel (DOM) steel tube, but other materials could be used in other embodiments.

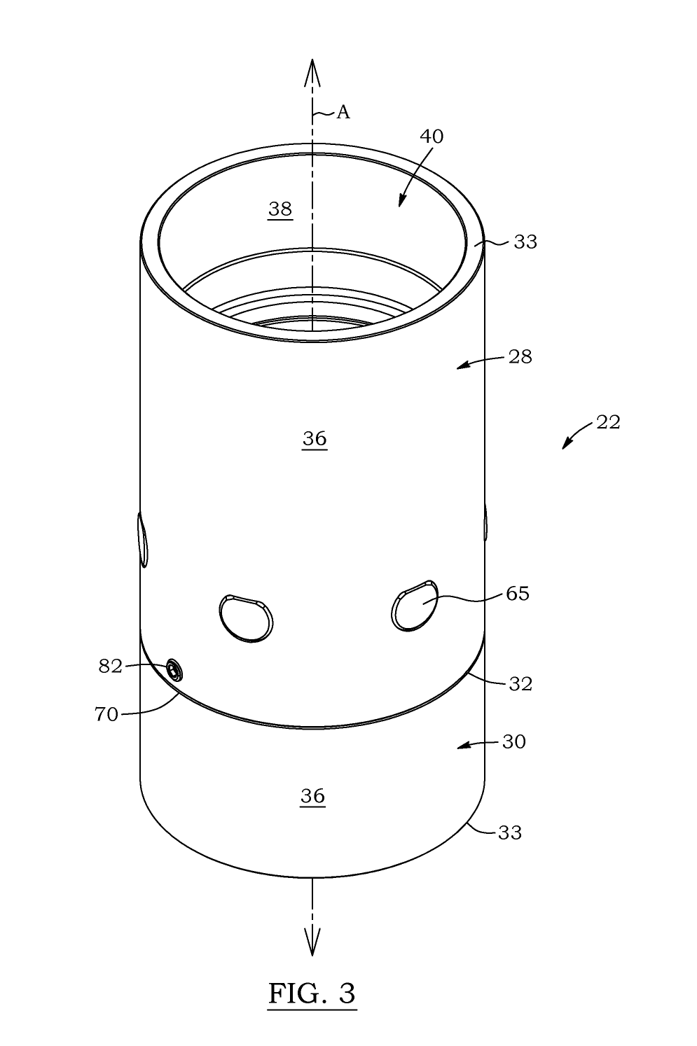

Referring now to FIGS. 2 and 3, there is shown that the hydraulic cylinder joint 22 includes a female collar 28 and a male collar 30 engageable with each other for coupling two adjacent pipe sections 24a, 24b. In the embodiment shown, the female collar 28 is secured to an end portion of the first pipe section 24a while the male collar 30 is secured to an end portion of the second pipe section 24b, adjacent to the end portion of the first pipe section 24a when coupled together. The female collar 28 and the male collar 30 are tubular components to allow engagement with each other through relative rotation and translation.

Referring more specifically to FIG. 2, each of the female collar 28 and the male collar 30 has a proximal axial end 32, an opposed distal axial end 33, a distal portion 34 extending toward the proximal axial end 32 from the distal axial end 33, and a proximal portion 35 extending toward the distal axial end 33 from the proximal axial end 32. Each of the female and male collars 28, 30 also has a circumferential outer surface 36 and an opposed circumferential inner surface 38, the inner surface 38 defining an inner channel 40 extending in the respective collar. The inner surfaces 38 and the outer surfaces 36 respectively define an internal diameter and an external diameter of the female collar 28 and the male collar 30. Moreover, each of the female and male collars 28, 30 is open-ended at both the proximal and distal axial ends 32, 33 thereof.

As used herein, term “proximal” refers to the axial ends of the female and male collars 28, 30 that are engageable with each other for coupling the first and second pipe sections 24a, 24b, while the term “distal” refers to the axial ends of the female and male collars 28, 30 opposite the respective proximal axial ends. Furthermore, when referring to the relative positioning of an element of or associated with the female collar, the terms “proximal” and “distal” respectively refer to the element being closer to and farther away from the proximal axial end of the female collar than another element or a reference point. Likewise, when referring to the relative positioning of an element of or associated with the male collar, the terms “proximal” and “distal” respectively refer to the element being closer to and farther away from the proximal axial end of the male collar than another element or a reference point.

The inner channels 40 of the female collar 28 and the male collar 30 are in fluid communication when engaged together in the coupled configuration. When the hydraulic cylinder joint 22, configured in the coupled configuration, is secured to the pipe sections 24a, 24b, the inner channels 40 of the female and male collars 28, 30 are in fluid communication with the inner channels 26 of the pipe sections 24a, 24b to allow a fluid flow therein.

To engage the pipe sections 24a, 24b with the hydraulic cylinder joint 22, the end portions of the first and second pipe sections 24a, 24b are respectively insertable in the inner channels 40 of the female collar 28 and the male collar 30, through the distal axial end 33 thereof. An external diameter of the first and second pipe sections 24a, 24b in the distal portions thereof 34 substantially corresponds to an internal diameter of the female collar 28 and the male collar 30 in the end portions thereof in a manner such that the outer surface of the pipe sections 24a, 24b is juxtaposed to the inner surfaces 38 of the female and male collars 28, 30, respectively. In an alternative embodiment, engaging the pipe sections 24a, 24b with the cylinder coupling joint 22 can involve inserting the distal portions 34 of the female collar 28 and the male collar 30 respectively into the end portions of the first and second pipe sections 24a, 24b. In this alternative embodiment, an external diameter of the female collar 28 and the male collar 30 in the distal portions 34 thereof substantially corresponds to an internal diameter of the first and second pipe sections 24a, 24b in the end portions thereof, in a manner such that the outer surfaces 36 of the female and male collars 28, 30 is juxtaposed to the inner surfaces of the pipe sections 24a, 24b, respectively.

When engaged with each other, the end portions of the first and second pipe sections 24a, 24b extend at least partially along the distal portions 34 of the respective one of the female and male collars 28, 30. The pipe sections 24a, 24b are secured to the respective one of the female and male collars 28, 30 to prevent disengagement therebetween and fluid leakage therefrom. For instance, and without being limitative, the female and male collars 28, 30 can be welded to the respective one of end portions of the pipe sections 24a, 24b. In an alternative embodiment, the end portions of the pipe sections 24a, 24b can be externally threaded and the inner surfaces 38 of the female and male collars 28, 30 can be internally threaded in the distal portions 34. In this embodiment, the female and male collars 28, 30 can be secured to the respective one of the pipe sections 24a, 24b by threaded engagement. In yet another alternative embodiment in which the distal portions 34 of the female and male collars 28, 30 are respectively insertable into the end portions of the first and second pipe sections 24a, 24b, the end portions of the pipe sections 24a, 24b can be internally threaded and the outer surfaces 36 of the female and male collars 28, 30 can be externally threaded in the distal portions 34. In this embodiment, the female and male collars 28, 30 can be secured to the respective one of the pipe sections 24a, 24b by threaded engagement.

When secured to the first and second pipe sections 24a, 24b, the proximal portions 35 of the female and male collars 28, 30 extend axially past the end portions of the first and second pipe sections 24a, 24b, respectively, as shown in FIG. 2.

When the female and male collars 28, 30 are secured to a respective one of the first and second pipe sections 24a, 24b, they can be engaged and locked together to couple the two pipe sections 24a, 24b together. As will be described in more detail below, the female and male collars 28, 30 are engageable together to provide a leak-free joint since the inner channel 26 of the pipe sections 24a, 24b is designed to sealingly contain a hydraulic fluid therein.

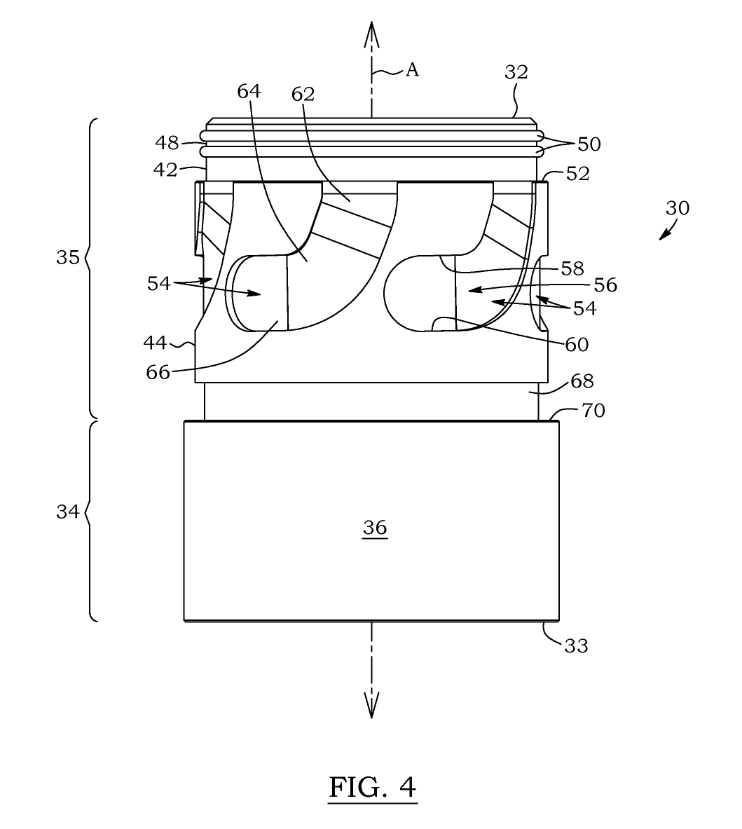

Referring now to FIGS. 4 to 6, an embodiment of the male collar 30 will be described in further detail. As mentioned above, in the embodiment shown, the male collar 30 can be divided, along the longitudinal axis A, into a distal portion 34, extending from the distal axial end 33, and an axially adjacent proximal portion 35, extending from the proximal axial end 32. As illustrated in FIGS. 1 and 2, the distal portion 34 is configured for attachment with an end portion of the pipe section 24b while the proximal portion 35 is received in the proximal portion 35 of the female collar 28 in the coupled configuration.

Turning back to FIGS. 4 to 6, the external diameter of the male collar 30 is variable along its length, i.e., parallel to the longitudinal axis A. The proximal portion 35 can be divided, along the longitudinal axis A, into a sealing region 42, extending from the proximal axial end 32 and an axially adjacent connecting region 44, extending between the sealing region 42 and the distal portion 34. The sealing region 42 is designed to provide a leak-free engagement between the female and male collars 28, 30, as will be described in more detail below. The connecting region 44 is designed to engage the female collar 28 and lock both collars 28, 30 together in the coupled configuration, as will be described in more detail below.

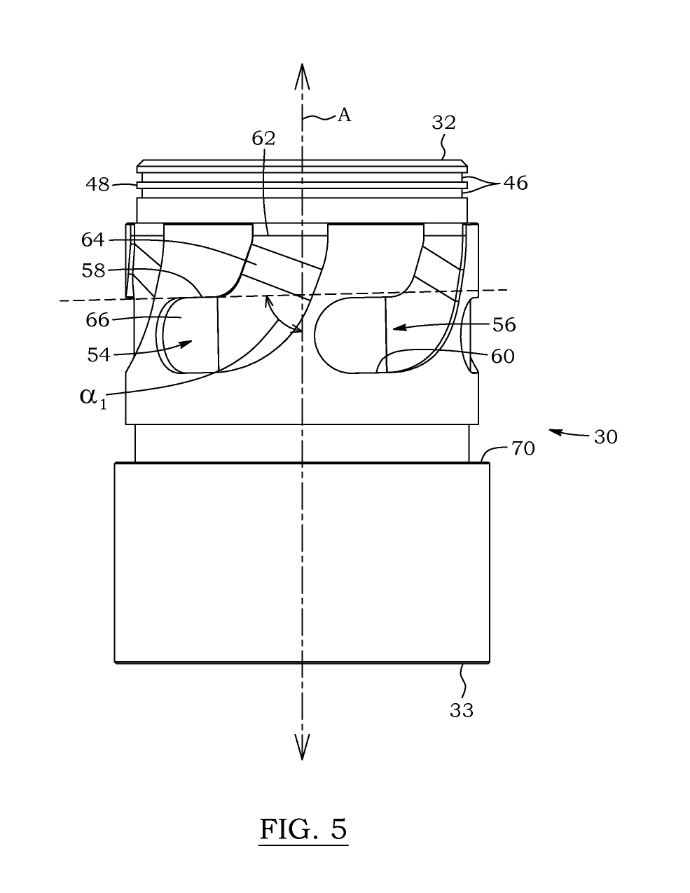

In the embodiment shown, the sealing region 42 includes two sealing member circumferential grooves 46 extending parallel to one another along the circumference of the sealing region 42, close to the proximal axial end 32, and axially spaced-apart from one another by a separation flange 48, as shown in FIG. 5. A resilient sealing member 50, such as an O-ring, is inserted in each one of the sealing member circumferential grooves 46 and protrudes outwardly past the separation flange 48, as shown in FIG. 4. In the coupled configuration, the resilient sealing members 50 abut against the inner surface 38 of the female collar 28 in the coupled configuration, as will be described in more detail below.

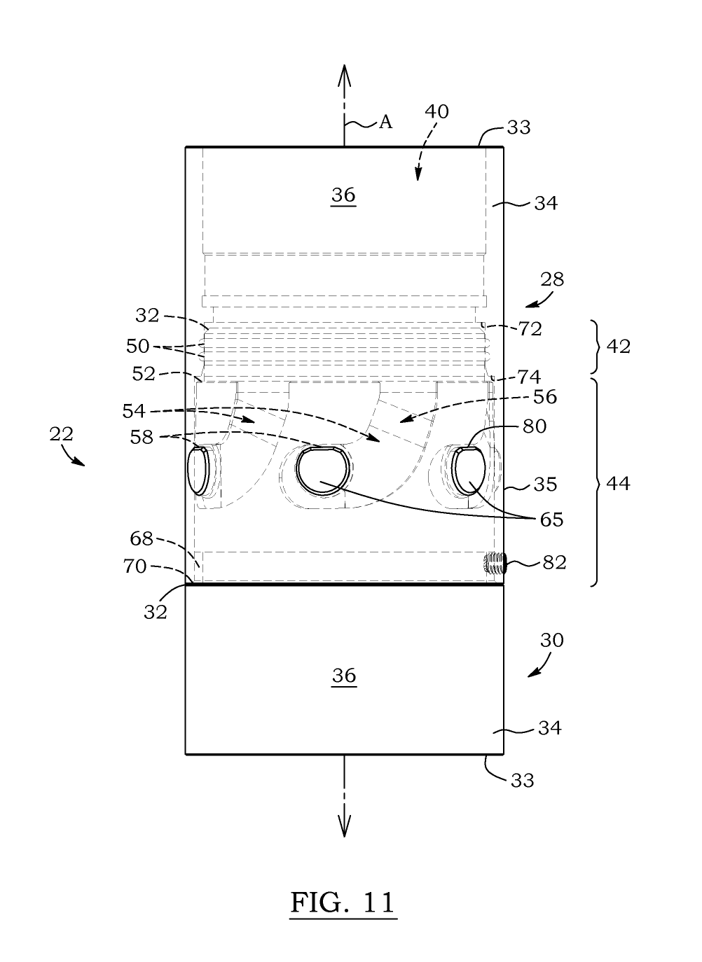

At their junction, the connecting region 44 has a larger external diameter than the sealing region 42 such that a circumferential rim 52 extends therebetween. The purpose of the circumferential rim 52 will be described in more detail below in reference to FIG. 11.

Referring still to FIGS. 4 to 6, the connecting region 44 includes a plurality of circumferentially distributed L-shaped grooves 54 extending from the circumferential rim 52 toward the distal axial end 33 of the male collar 30. In the illustrated embodiment, the connecting region 44 includes six L-shaped grooves 54 that are substantially uniformly spaced-apart from one another and that circumscribe a periphery of the male collar 30 in the connecting region 44 thereof. The L-shaped grooves 54 are part of a coupling assembly allowing engagement and locking of the female and male collars 28, 30, as will be described in more detail below.

Each one of the L-shaped grooves 54 includes a disk guiding path 56 defined between a proximal abutting edge 58 and a distal edge 60 thereof. Along a length of the disk guiding path 56, the proximal abutting edge 58 and the distal edge 60 are substantially uniformly spaced-apart in a manner such that the disk guiding path 56 has a substantially uniform width along its length. In an embodiment, the disk guiding path 56 is free of cavities, grooves, notches or other widthwise recessed structures defined along the disk guiding path 56 inside which the protruding disk 65 could be inserted or received. As will be described in more detail below, coupling of the two collars 28, 30 is ensured by the abutment of the proximal axial end 32 of the female collar against a stopper formed in the male collar 30 in combination with the abutment of the protruding disks 65 against the proximal abutting edge of the corresponding L-shaped grooves 54.

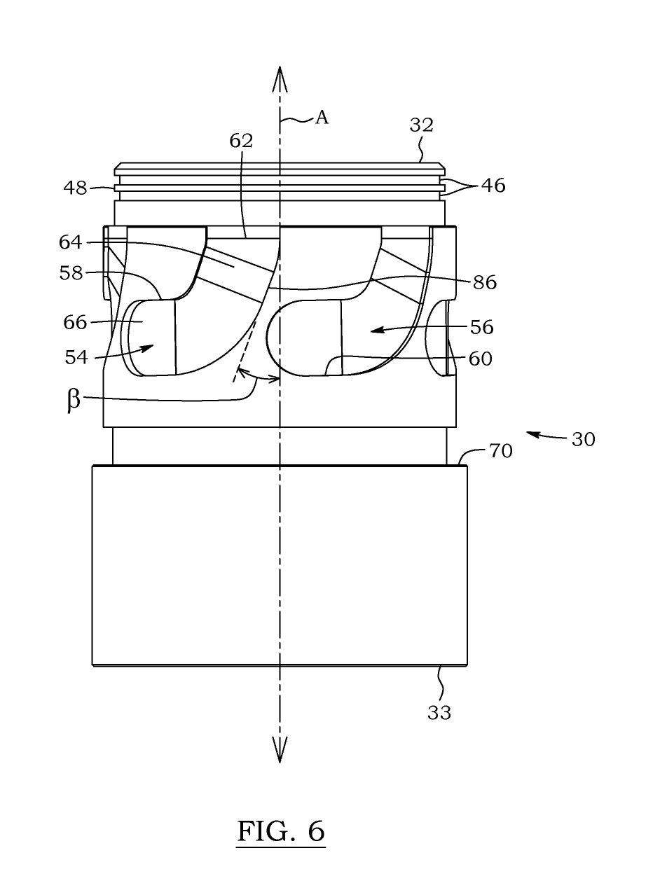

The disk guiding path 56 of the L-shaped grooves 54 can be divided into three successive sections: an introduction section 62, a transition section 64, and a locking section 66. The introduction section 62 is open at the junction with the circumferential rim 52, allowing insertion of a protruding disk 65 therein, as will be described in more detail below. As shown in FIG. 6, at the junction with the circumferential rim 52, the introduction section 62, and thus the disk guiding path 56, extends substantially parallel to the longitudinal axis A. The introduction section 62 is followed by the transition section 64. In the embodiment shown, the transition section 64 is obliquely oriented with the longitudinal axis A and exhibits with a relatively smooth curvature. In the illustrated embodiment, the transition section 64 includes a straight mid-segment 86 making an angle β of about 25° with the longitudinal axis A, as shown in FIG. 6. However, the angle between the straight mid-segment 86 and the longitudinal axis A may be varied in other embodiments. For example, in a non-limitative embodiment, the straight mid-segment 86 of the transition section 64 makes an angle of about 0° to about 80° with the longitudinal axis A, and in another non-limitative embodiment, the straight mid-segment 86 of the transition section 64 makes an angle of about 20° to about 30° with the longitudinal axis A. The transition section 64 is followed by the locking section 66, which receives a respective one of the protruding disks 65, as will be described in more detail below. In an exemplary embodiment, a circumferential extent (e.g., perpendicular to the longitudinal axis A in the Figures) of the L-shaped grooves 54 is equal to or shorter than a corresponding longitudinal extent (e.g., parallel to the longitudinal axis A in the Figures) of the L-shaped grooves 54. Such a configuration can allow the number of L-shaped grooves 54 provided with the hydraulic cylinder joint 22 to be increased which, in turn, can enhance the coupling strength achievable by the hydraulic cylinder joint.

As shown in FIG. 5, the locking section 66 defines an angle with the longitudinal axis A. In the embodiment shown, the angle α₁ is about 88.7°. However, it is appreciated that, in an alternative embodiment, the angle α₁ can range between about 81.5° and about 89° with the longitudinal axis A. The angle α₁ between the proximal abutting edge 58 and the longitudinal axis A ensures that the protruding disks 65 remain abutted against the proximal abutting edge 58 in the coupled configuration by providing enough friction between the disks 65 and the abutting edge 58 to prevent inadvertent sliding and disengagement therebetween, as will be described in more detail below.

In the embodiment shown in the Figures, the locking section 66 ends with a curved end due to the tolerance of the machining tool used to machine the L-shaped grooves 54. However, this curved end is optional since the protruding disks 65 will usually not reach the curved end of the locking section 66 in the coupled configuration, as will be described in more detail below.

Referring to FIG. 4, closer to the distal axial end 33 of the male collar 30, the connecting region 44 includes a distal circumferential groove 68, followed by a circumferential female-collar stopping shoulder 70, the stopping shoulder 70 being located closer to the distal axial end 33 than the distal circumferential groove 68. The external diameter of the male collar 30 in the distal circumferential groove 68 is smaller than in the adjacent portions, i.e., the portions including the L-shaped grooves 54 and the circumferential female-collar stopping shoulder 70. The circumferential female-collar stopping shoulder 70 stops and prevents further insertion of the male collar 30 inside the female collar 28 when the coupled configuration is reached. More specifically, in the coupled configuration, the proximal axial end 32 of the female collar 28 abuts against the circumferential female-collar stopping shoulder 70, as will be described in more detail below in reference to FIG. 11.

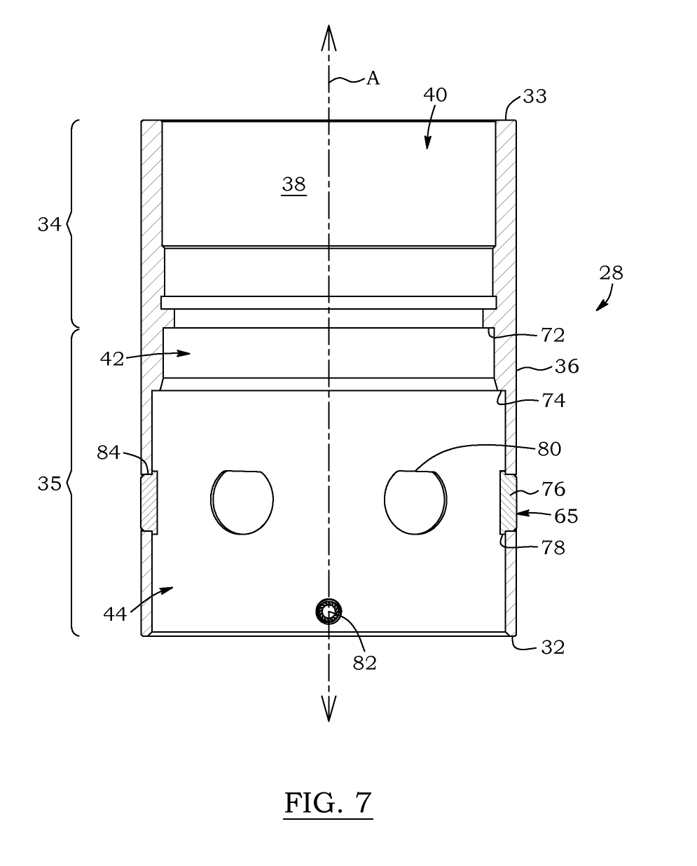

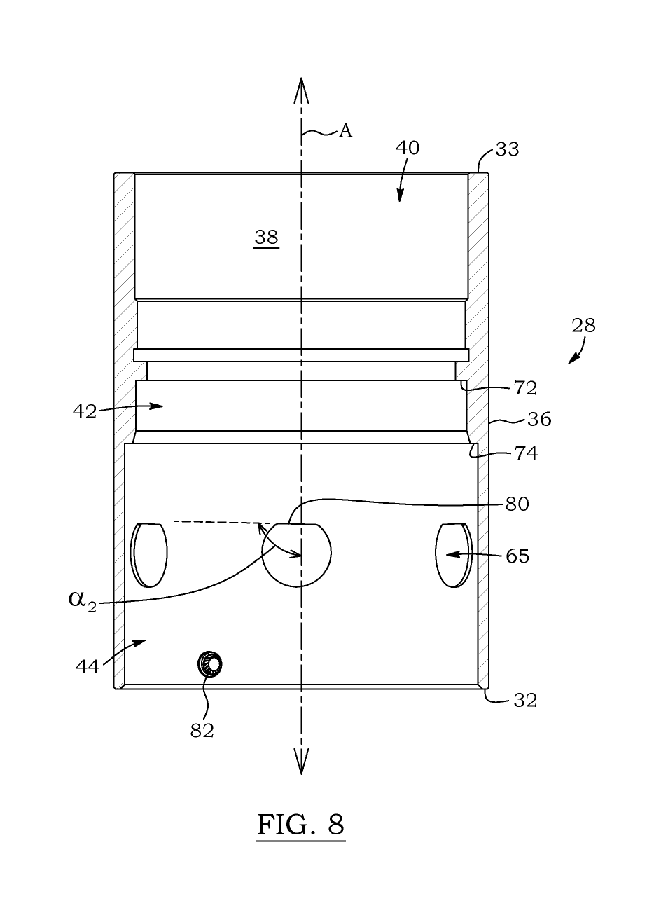

Referring now to FIGS. 7 and 8, an embodiment of the female collar 28 will be described in further detail. As for the male collar 30, the female collar 28 can be divided, along the longitudinal axis A, into a distal portion 34 extending from the distal axial end 33 and an adjacent proximal portion 35 extending from the proximal axial end 32. As illustrated in FIGS. 1 and 2, the distal portion 34 is configured for attachment with an end portion of the pipe section 24a while the proximal portion 35 receives therein the proximal portion 35 of the male collar 30 in the coupled configuration.

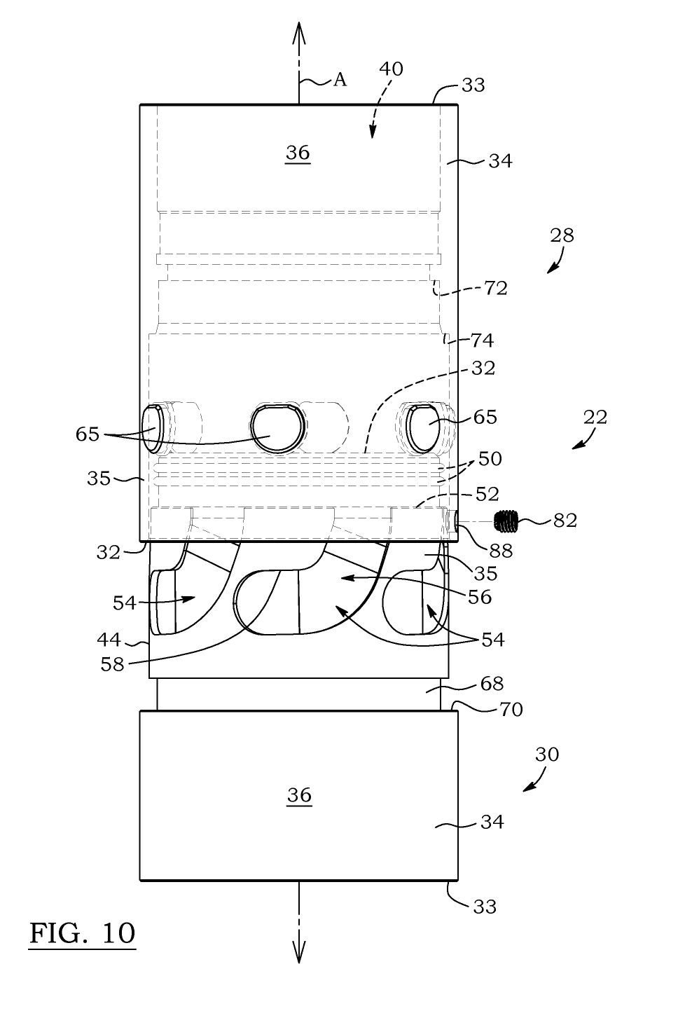

Turning back to FIGS. 7 and 8, the proximal portion 35 of the female collar 28 can be divided, along the longitudinal axis A, into a connecting region 44, extending from the proximal axial end 32 and an adjacent sealing region 42, extending between the connecting region 44 and the distal portion 34. Similarly to the sealing region 42 of the male collar 30 (see, e.g., FIG. 4), the sealing region 42 of the female collar 28 is designed to provide a leak-free engagement between the female and male collars 28, 30. More particularly, as shown in FIGS. 10 and 11 described further below, the sealing region 42 of the female collar 28 is designed to receive the sealing region 42 of the male collar 30 in the coupled configuration. Meanwhile, the connecting region 44 of the female collar 28 is designed to receive the connecting region 44 of the male collar 30 and lock both collars 28, 30 together in the coupled configuration.

Referring back to FIGS. 7 and 8, the sealing region 42 of the female collar 28 can include a circumferential proximal-end stopping rim 72 against which the proximal end 32 of the male collar 30 abuts in the coupled configuration (see FIG. 11). A circumferential connecting-region abutting rim 74 can additionally or alternatively be defined between the sealing region 42 and the connecting region 44 of the female collar 28. In such case, a proximal end of the connecting region 44 of the male collar 30 abuts (e.g., the circumferential rim 52 of the male collar 30) against the circumferential connecting-region abutting rim 74 in the coupled configuration (see FIG. 11).

In FIGS. 7 and 8, the diameter of the inner channel 40 of the female collar 28 is wider in the connecting region 44 than in the sealing region 42. The internal diameter of the inner channel 40 of the female collar 28 is substantially complementary to the external diameter of the male collar insertable therein.

In the embodiment shown, the connecting region 44 of the female collar 28 includes a plurality of circumferentially distributed protruding disks 65 protruding inwardly from the inner surface 38 of the female collar 28 into the inner channel 40. The protruding disks 65 are axially spaced-apart from and closer to the proximal axial end 32 than the circumferential connecting-region abutting rim 74. In the illustrated embodiment, the connecting region 44 includes six protruding disks 65 that are substantially uniformly spaced-apart from one another and that circumscribe a periphery of the female collar 28 in the connecting region 44 thereof. With the L-shaped grooves 54 of the male collar 30, the protruding disks 65 are part of a coupling assembly allowing engagement and locking of the female and male collars 28, 30, as will be described in more detail below.

The protruding disks 65 are shaped and sized to be insertable in the L-shaped grooves 54 of the male collar 30, slidable therein from the introduction section 62 to the locking section 66 to be configured in the coupled configuration.

The L-shaped grooves 54 and the protruding disks 65 are provided in pairs, that is, a one-to-one correspondence exists between the L-shaped grooves 54 and the protruding disks 65, wherein each one of the protruding disks 65 is insertable in a corresponding one of the L-shaped grooves 54. Accordingly, the number of protruding disks 65 corresponds to the number of L-shaped grooves 54.

In the embodiment shown in the Figures, the female and male collars, 28 30 include respectively six substantially evenly spaced-apart protruding disks 65 and six substantially evenly spaced-apart L-shaped grooves 54. However, it is appreciated that the number of protruding disks 65 and L-shaped grooves 54 can vary from the embodiment shown. The coupling strength between the female and male collars 28, 30 in the coupled configuration generally increases with the number of protruding disks 65 and L-shaped grooves 54. It will also be understood that while in the illustrated embodiment while the protruding disks 65 and the L-shaped grooves 54 are distributed evenly along the circumference of the connecting regions 44 of the proximal portions 35 of the female and male collars 28, 30, respectively, an uneven circumferential distribution of the protruding disks 65 and L-shaped grooves 54 can be used in another embodiment. Furthermore, while the different L-shaped grooves 54 and associated protruding disks 65 are identical in the illustrated embodiment, configurations where the grooves 54 and disks 65 are not all identical may be employed.

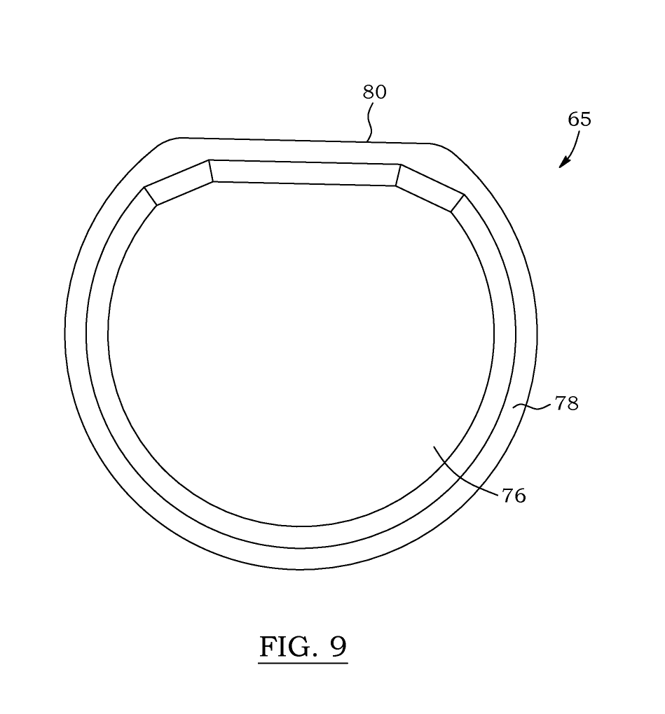

In the embodiment shown in the Figures, the protruding disks 65 are inserted and secured in through holes 84 defined in the female collar 28. As shown in FIG. 9, the protruding disks 65 have a stem 76 and a head 78, the size of the head 78 being larger than the size of the stem 76. The stem 76 is insertable in a corresponding one of through hole 84, the shape and size of which correspond to the shape and size of the stems 76 for the protruding disks 65 to be maintained and secured therein by a squeeze fit. Alternatively, the protruding disks 65 can be maintained a secured in their respective through holes 84 by welding or be machined integrally with the female collar 28. The head 78 abut against the inner surface 38 of the female collar 28 when the protruding disks 65 are mounted thereto and protrude in the inner channel 40. In the embodiment shown, the shape of the heads 78 is substantially similar to the shape of the stems 76 but could differ in other embodiments.

In the embodiment shown, the protruding disks 65 have a flat surface 80 (or a meplat) along the portion of their periphery that is closest to the distal axial end 33 of the female collar 28 when the protruding disks 65 are mounted to the female collar 28. The flat surface 80 of each one of the protruding disks 65 abuts against the proximal abutting edge 58 of the respective L-shaped grooves 54 when the female and male collars 28, 30 are in the coupled configuration. As shown in FIG. 8, in an embodiment, the flat surfaces 80 of the protruding disks 65 define an angle α₂ with the longitudinal axis A which substantially correspond to the angle α₁ defined between the proximal abutting edges 58 of the L-shaped grooves 54 and the longitudinal axis A (see FIG. 5). Thus, in an embodiment, the angle α₂ can range between about 81.5° and about 89° with the longitudinal axis A. In the embodiment shown, the through holes 84 in which the protruding disks 65 are fitted each also include a flat surface corresponding to and receiving the flat surface 80 of the respective protruding disk 65. Like the flat surfaces 80 of the protruding disks 65, the flat surfaces of the through holes 84 are angled at an angle α₂ to receive the protruding disks 65 therein and secure them by a squeeze fit.

It is appreciated that the shape of the protruding disks 65 and that of the corresponding through holes 84 can vary from the embodiment shown. For instance, and without being limitative, the protruding disks 65 and through holes 84 need not include a flat surface 80, but can be substantially circular in shape.

Proximate to the proximal axial end 32, the female collar 28 can include a pressure screw 82 inserted in a threaded aperture 88 (see FIG. 10) and threadedly engageable therein. In the coupled configuration, the pressure screw 82 presses radially inwardly against the male collar 30.

Turning now to FIGS. 10 and 11, the engagement of the two collars 28, 30 from a disengaged configuration (FIG. 10) to the coupled configuration (FIG. 11) will be described. In FIGS. 10 and 11, pipe sections 24a, 24b are not mounted to the collars 28, 30. However, it is appreciated that, to couple two pipe sections 24a, 24b, the collars 28, 30 are first secured to a respective of the pipe sections 24a, 24b and subsequently coupled together as will be described in more detail below.

In order to couple the two collars 28, 30 together, the male collar 30 is first inserted through the proximal axial end 32 and into the inner channel 40 of the female collar 28. In the event the protruding disks 65 are already aligned with the introduction section 62 of the L-shaped grooves 54, the female and male collars 28, 30 may then be linearly translated with respect to each other substantially along the axis A until each protruding disk 65 reaches and enters in the introduction section 62 of a respective one of the L-shaped grooves 54. However, in the event the protruding disks 65 are misaligned with the introduction section 62 of the L-shaped grooves 54, the substantially linear insertion just described is effected until the protruding disks 65 abut against the circumferential rim 52 of the male collar 30. Then, the female and male collars 28, 30 is rotated relative to each other until the protruding disks 65 become aligned with the introduction section 62 of the L-shaped grooves 54. In a non-limitative embodiment, the female collar 28 is rotated clockwise until the protruding disks 65 are aligned with the introduction section 62 of the L-shaped grooves 54. When proper alignment is reached, the linear translation motion can be resumed to enable insertion of each protruding disk 65 in the introduction section 62 of a respective one of the L-shaped grooves 54.

Then, a relative rotation is performed to progressively engage the protruding disks 65 further along the disk guiding path 56 of the L-shaped grooves going successively from the introduction section 62 to the transition section 64 and from the transition section 64 to locking section 66. This relative rotation motion is continued until the protruding disks 65 are engaged in the locking section 66 with the flat surfaces 80 of the protruding disks 65 (or any proximal surface thereof) abutting against the proximal abutting edges 58 of the L-shaped grooves 54, at which point the proximal axial end 32 of the female collar 28 also abuts against the circumferential female-collar stopping shoulder 70 formed in the male collar 30 and a coupled configuration is reached. As shown in FIG. 11, in the coupled configuration, the insertion of the male collar 30 in the inner channel 40 of the female collar 28 is stopped when the proximal axial end 32 of the female collar 28 abuts against the circumferential female-collar stopping shoulder 70 formed in the male collar 30. Accordingly, the circumferential female-collar stopping shoulder 70 prevents further relative displacement of the female and male collars 28, 30 in a first axial direction (e.g., pointing toward the bottom of the page in FIG. 11, that is, toward the male side of the hydraulic cylinder joint 22). Meanwhile, the proximal abutting edges 58 of the L-shaped grooves 54 prevent further displacement in a second axial direction (e.g., pointing toward the top of the page in FIG. 11, that is, toward the female side of the hydraulic cylinder joint 22), opposed to the first axial direction. In the coupled configuration, the proximal portions 35 of the female and male collars 28, 30 are radially superposed.

The relative rotation motion performed to engage the protruding disks 65 in the locking sections 66 tightens the coupling between the female and male collars 28, 30 and acts to prevent their inadvertent or unwanted disengagement.

In the coupled configuration, the sealing region 42 of the male collar 30 is inserted or contained in the sealing region 42 of the female collar 28 with the resilient sealing members 50 being radially compressed on the inner surface 38 of the female collar 28. Fluid leakage between the female and male collars 28, 30 can thus be prevented.

As mentioned above, the resilient sealing members 50 are mounted to the sealing region 42 of the male collar 30, which has a smaller diameter than the connecting region 44 adjacent thereto. Therefore, upon insertion of the male collar 30 into the inner channel 40 of the female collar 28, any displacement or disengagement of the resilient sealing members 50 from the sealing member circumferential grooves 46 is substantially prevented or at least mitigated. This is because the resilient sealing members 50 remain spaced-apart from the inner surface 38 of the female collar 28 in the connecting region 44 thereof, coming into contact with and abutting against the inner surface 38 of the female collar 28 only upon engagement with the sealing region 42 of the female collar 28. As mentioned above, when received in the sealing region 42 of the female collar 28, the resilient sealing members 50 are radially compressed against the inner surface 38 of the female collar 28 to achieve a fluid-tight joint.

Furthermore, as shown in FIG. 10, the engagement of the connecting region 44 of the female collar 28 over the connecting region 44 of the male collar 28 is initiated before insertion of the sealing region 42 of the male collar 30 in the sealing region 42 of the female collar 28. This ensures that the two collars 28, 30 are aligned along the longitudinal axis A when the sealing region 42 of the male collar 30 is inserted in the sealing region 42 of the female collar 28, thereby preventing or at least minimizing displacement of the resilient sealing members 50 from the sealing member circumferential grooves 46.

In an embodiment, compression of the resilient sealing members 50 against the inner surface 38 of the female collar 28 begins when the protruding disks 65 are located in the transition section 64 of the L-shaped grooves 54.

The circumferential rim 52 defined between the connecting region 44 and the sealing region 42 of the male collar 30 abut the circumferential connecting-region abutting rim 74 defined between the sealing region 42 and the connecting region 44 of the female collar 28.

As mentioned above, in the embodiment shown, the protruding disks 65 are engaged in the locking section 66 of the L-shaped grooves 54, for example near the middle thereof, and abut against the proximal abutting edges 58. In the embodiment shown, the diameter of the protruding disks 65 is smaller than the width of the disk guiding path 56. Thus, the protruding disks 65 are spaced-apart from the distal edge 60 of the L-shaped grooves 54, in the coupled configuration. As mentioned above, in the embodiment shown, the protruding disks 65 do not abut against the end of the L-shaped grooves 54 in the coupled configuration.

For further securing the hydraulic cylinder joint 22, the pressure screw 82 can be rotated until its head abuts against the male collar 30 and, more particularly, the outer surface 36 in the vicinity of the distal circumferential groove 68.

In an embodiment, the connecting regions 44 of the female and male collars 28, 30 are thread free. In an embodiment, the female and male collars 28, 30 are also thread free.

The pipe sections 24a, 24b coupled together through the hydraulic cylinder joint 22 are aligned along the longitudinal axis A. When the hydraulic cylinder pipe 20 is vertically oriented, the hydraulic cylinder joint 22 is designed in a manner such that the lower pipe section supports the weight of the upper pipe section. In the coupled configuration, the hydraulic cylinder joint 22 provides a mechanically strong, fluid tight joint. When engaged together, the two collars 28, 30 can be secured in a single coupled configuration, wherein the pipe sections 24a, 24b, secured thereto, are aligned. This prevents or at least reduces alignment problems that occur with conventional threaded sections.

The above-described coupling assembly substantially mechanically resists to forces applied thereon.

It is appreciated that several modifications can be foreseen to the above-described embodiment. For instance, the male collar 30 can be provided with disks 65 protruding from its outer surface 36 and engageable in L-shaped grooves 54 defined in the inner surface 38 of the female collar 28. Similarly, the resilient sealing members 50 can be mounted to the inner surface 38 of the female collar 28. The shape of the protruding disks 65 can vary from the embodiment shown. Furthermore, the protruding disks 65 can be secured, such as by welding, or integrally provided with the respective one of the female and male collars 28, 30, rather than inserted in dedicated through holes 84 defined therein.

Furthermore, in an embodiment, the L-shaped grooves 54 need not include a transition section 64 extending between the introduction section 62 and the locking section 66. The provision of a transition section 64 can permit a gradual transition between the introduction section 62, which is substantially parallel to the longitudinal axis A, and the locking section 66, which is oriented close to normal to the longitudinal axis A. In another implementation, one or more of the angle β of the transition section 64, the angle α₁ between the longitudinal axis A and the proximal abutting edges 58 of the L-shaped grooves 54, the angle α₂ between the longitudinal axis A and the flat surfaces 80 of the protruding disks 65 and the angle made by the transition section 64 with the longitudinal axis A can vary from the values mentioned above in reference to one of the possible embodiments. In addition, while the ratio of the circumferential to the longitudinal extent of the L-shaped grooves 54 is close to unity in the illustrated embodiment (i.e., the L-shaped grooves could substantially be inscribed in a square), this ratio could be increased or decreased to suit the requirements of a particular application.

Moreover, the sealing region 42 can include one or more resilient sealing members 50 to provide a fluid tight coupling between the collars 28, 30.

It is also to be noted that while in the embodiment shown in the Figures the procedure of configuring the female and male collars 28, 30 in the coupled configuration involves (i) abutting the proximal axial end 32 of the female collar 28 against a circumferential female-collar stopping shoulder 70 formed in the male collar 30, and (ii) abutting each of the protruding disks 65 against the proximal abutting edge 58 of the respective one of the L-shaped grooves 54, the converse arrangement may be employed in another embodiment. Namely, in such an alternative embodiment, the collar stopping shoulder is instead associated with the female collar and acts as a circumferential male-collar stopping shoulder protruding inwardly from the inner surface of the female collar and axially spaced-apart from the proximal axial end thereof. Furthermore, in this embodiment, the coupled configuration instead involves (i) abutting the proximal axial end of the male collar against the circumferential male-collar stopping shoulder formed in the female collar, and (ii) abutting each of the protruding disks 65 against a distal abutting edge of the respective one of the L-shaped grooves.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A hydraulic cylinder pipe comprising:
a first pipe section;
a second pipe section aligned with the first pipe section along a longitudinal axis; and
a hydraulic cylinder joint coupling the first pipe section and the second pipe section, the hydraulic cylinder joint comprising:
a female collar having a proximal axial end and an inner surface defining an inner channel extending axially therein, the female collar extending from the first pipe section along the longitudinal axis;
a male collar having a proximal axial end, an outer surface, and an opposed inner surface defining an inner channel extending axially therein, the male collar extending from to the second pipe section along the longitudinal axis;
a plurality of circumferentially distributed L-shaped grooves formed in one of the inner surface of the female collar and the outer surface of the male collar, each L-shaped groove having an introduction section and a locking section with an abutting edge, the introduction section being closer to the proximal axial end of the one of the female collar and the male collar than the locking section;
a corresponding plurality of circumferentially distributed protruding disks provided in the other one of the inner surface of the female collar and the outer surface of the male collar, the protruding disks protruding from the other one of the inner surface of the female collar and the outer surface of the male collar; and
a circumferential collar stopping shoulder associated with one of the female and male collars, wherein the circumferential collar stopping shoulder is respectively one of a circumferential female-collar stopping shoulder protruding outwardly from the outer surface of the male collar and axially spaced-apart from the proximal axial end thereof and a circumferential male collar stopping shoulder protruding inwardly from the inner surface of the female collar and axially spaced-apart from the proximal axial end thereof;
the male collar being inserted in the inner channel of the female collar with the one of the female and male collars not associated with the circumferential collar stopping shoulder abutting against the circumferential collar stopping shoulder and with each of the protruding disks being engaged in the locking section of a corresponding one of the L-shaped grooves and abutting against the abutting edge thereof.

2. The hydraulic cylinder pipe as claimed in claim 1, wherein the circumferential collar stopping shoulder is associated with the male collar, and the abutting edge of each of the L-shaped grooves is a proximal abutting edge.

3. The hydraulic cylinder pipe as claimed in claim 1, wherein the hydraulic cylinder joint further comprises at least one circumferential resilient sealing member, each circumferential resilient sealing member circumscribing one of the inner surface of the female collar and the outer surface of the male collar, the at least one circumferential resilient sealing member being closer to the introduction sections of the L-shaped grooves than to the locking sections.

4. The hydraulic cylinder pipe as claimed in claim 3, wherein the male collar comprises at least one circumferential groove defined in the outer surface thereof, adjacent to the proximal axial end thereof, each of the at least one circumferential resilient sealing member being inserted in a corresponding one of the at least one circumferential groove.

5. The hydraulic cylinder pipe as claimed in claim 3, wherein each one of the male collar and the female collar comprises a connecting region and a sealing region, with the connecting region of the female collar being closer to the proximal axial end than the sealing region and the sealing region of the male collar being closer to the proximal axial end than the sealing region, an external diameter of the male collar being larger in the connecting region than in the sealing region and the inner channel of the female collar being wider in the connecting region than in the sealing region.

6. The hydraulic cylinder pipe as claimed in claim 1, wherein each of the L-shaped grooves has an opposing edge, axially spaced-apart from the abutting edge, the abutting edge and the opposing edge defining therebetween a disk guiding path extending continuously between the introduction section and the locking section.

7. The hydraulic cylinder pipe as claimed in claim 6, wherein a width of the disk guiding path is substantially uniform from the introduction section to the locking section.

8. The hydraulic cylinder pipe as claimed in claim 7, wherein the opposing edge of each of the L-shaped grooves is axially spaced-apart from the corresponding one of the protruding disks.

9. The hydraulic cylinder pipe as claimed in claim 1, wherein the abutting edge of the locking section of each of the L-shaped grooves defines an angle ranging between 81.5° and 89° with the longitudinal axis.

10. The hydraulic cylinder pipe as claimed in claim 1, wherein the L-shaped grooves are defined in the outer surface of the male collar and the protruding disks protrude from the inner surface of the female collar.

11. The hydraulic cylinder pipe as claimed in claim 1, wherein each L-shaped groove has a transition section extending between the introduction and the locking sections thereof.

12. The hydraulic cylinder pipe as claimed in claim 1, wherein the plurality of L-shaped grooves consists of six L-shaped grooves, and the corresponding plurality of protruding disks consists of six protruding disks.

13. The hydraulic cylinder pipe as claimed in claim 1, wherein each of the protruding disks includes a flat surface along a portion of a periphery thereof, the flat surface abutting against the abutting edge of the corresponding one of the L-shaped grooves.

14. The hydraulic cylinder pipe as claimed in claim 1, wherein each of the protruding disks is engaged in the locking section of the corresponding one of the L-shaped grooves in a spaced-apart relationship with an end of L-shaped groove in the locking section.

15. A hydraulic cylinder joint for a hydraulic cylinder including a first pipe section and a second pipe section, the hydraulic cylinder joint comprising:
a female collar having a proximal axial end and an inner surface defining an inner channel extending axially therein along a longitudinal axis thereof, the female collar being securable to the first pipe section;
a male collar having a proximal axial end, an outer surface, and an opposed inner surface defining an inner channel extending axially therein along a longitudinal axis thereof, the male collar being securable to the second pipe section;
a plurality of circumferentially distributed L-shaped grooves formed in one of the inner surface of the female collar and the outer surface of the male collar, each L-shaped groove having an introduction section and a locking section with an abutting edge, the introduction section being closed to proximal axial end of the one of the female collar and the male collar than the locking section;
a corresponding plurality of circumferentially distributed protruding disks provided in the other one of the inner surface of the female collar and the outer surface of the male collar, the protruding disks protruding from the other one of the inner surface of the female collar and the outer surface of the male collar; and
a circumferential collar stopping shoulder associated with one of the female and male collars, wherein the circumferential collar stopping shoulder is respectively one of a circumferential female-collar stopping shoulder protruding outwardly from the outer surface of the male collar and axially spaced-apart from the proximal axial end thereof and a circumferential male collar stopping shoulder protruding inwardly from the inner surface of the female collar and axially spaced-apart from the proximal axial end thereof;
the male collar being insertable in the inner channel of the female collar through the proximal axial end of the female collar and being configurable in a coupled configuration with the female collar, wherein the one of the female and male collars not associated with the circumferential collar stopping shoulder abuts against the circumferential collar stopping shoulder and wherein each of the protruding disks is engaged in the locking section of a corresponding one of the L-shaped grooves and abuts against the abutting edge thereof.

16. The hydraulic cylinder joint as claimed in claim 15, wherein the circumferential collar stopping shoulder is associated with the male collar, and the abutting edge of each of the L-shaped grooves is a proximal abutting edge.

17. The hydraulic cylinder joint as claimed in claim 15, further comprising at least one circumferential resilient sealing member, each circumferential resilient sealing member circumscribing one of the inner surface of the female collar and the outer surface of the male collar, wherein, in the coupled configuration, the at least one circumferential resilient sealing member are closer to the introduction sections of the L-shaped grooves than to the locking sections.

18. The hydraulic cylinder joint as claimed in claim 17, wherein the male collar comprises at least one circumferential groove defined in the outer surface thereof, adjacent to the proximal axial end thereof, each of the at least one circumferential resilient sealing member being inserted in a corresponding one of the at least one circumferential groove.

19. The hydraulic cylinder joint as claimed in claim 17, wherein each one of the male collar and the female collar comprises a connecting region and a sealing region, with the connecting region of the female collar being closer to the proximal axial end than the sealing region and the sealing region of the male collar being closer to the proximal axial end than the sealing region, an external diameter of the male collar being larger in the connecting region than in the sealing region and the inner channel of the female collar being wider in the connecting region than in the sealing region.

20. The hydraulic cylinder joint as claimed in claim 15, wherein each of the L-shaped grooves has a free edge, axially spaced-apart from the abutting edge, the abutting edge and the free edge defining therebetween a disk guiding path extending continuously between the introduction section and the locking section.

21. The hydraulic cylinder joint as claimed in claim 20, wherein a width of the disk guiding path is substantially uniform from the introduction section to the locking section.

22. The hydraulic cylinder joint as claimed in claim 20, wherein, in the coupled configuration, the free edge of each of the L-shaped grooves is axially spaced-apart from the corresponding one of the protruding disks.

23. The hydraulic cylinder joint as claimed in claim 15, wherein the abutting edge of the locking section of each of the L-shaped grooves defines an angle ranging between 81.5° and 89° with the longitudinal axis of the one of the female collar and the male collar.

24. The hydraulic cylinder joint as claimed in claim 15, wherein the L-shaped grooves are defined in the outer surface of the male collar and the protruding disks protrude from the inner surface of the female collar.

25. The hydraulic cylinder joint as claimed in claim 15, wherein each L-shaped groove has a transition section extending between the introduction and the locking sections thereof.

26. The hydraulic cylinder joint as claimed in claim 15, wherein the plurality of L-shaped grooves consists of six L-shaped grooves, and the corresponding plurality of protruding disks consists of six protruding disks.

27. The hydraulic cylinder joint as claimed in claim 15, wherein each of the protruding disks includes a flat surface along a portion of a periphery thereof, and wherein, in the coupled configuration, the flat surface abuts against the abutting edge of the corresponding one of the L-shaped grooves.

28. The hydraulic cylinder joint as claimed in claim 15, wherein, in the coupled configuration, each protruding disk is engaged in the locking section of the corresponding one of the L-shaped grooves in a spaced-apart relationship with an end L-shaped groove in the locking section.
